(19) United States
(12) Patent Application Publication
(10) Pub. No.: US 2025/0309267 A1
(43) Pub. Date: Oct. 2, 2025

(54) NEGATIVE ELECTRODE AND LITHIUM ION SECONDARY BATTERY

(71) Applicant: TOYOTA JIDOSHA KABUSHIKI KAISHA, Toyota-shi Aichi-ken (JP)

(72) Inventors: Ryoto NOGAMI, Toyota-shi Aichi-ken (JP); Daisuke HORIKAWA, Toyota-shi Aichi-ken (JP); Yuki SUGIMOTO, Kariya-shi Aichi-ken (JP); Hiroshi IWATA, Kariya-shi Aichi-ken (JP)

(73) Assignee: TOYOTA JIDOSHA KABUSHIKI KAISHA, Toyota-shi Aichi-ken (JP)

(21) Appl. No.: 19/032,564

(22) Filed: Jan. 21, 2025

(30) Foreign Application Priority Data
Mar. 26, 2024 (JP) 2024-050232

(51) Int. Cl. H01M 4/587; H01M 4/02; H01M 10/0525

(52) U.S. Cl. CPC H01M 4/587; H01M 2004/021; H01M 10/0525

(57) ABSTRACT

A negative electrode of the present disclosure contains a negative electrode active material having an average particle size of 2 μm or more and 25 μm or less, and a proportion of secondary particles of 50%, and a tortuosity is 1 or more and 20 or less, and a migration index is 1.0 or more and 1.6 or less.

### CROSS-REFERENCE TO RELATED APPLICATION

This application claims priority to Japanese Patent Application No. 2024-050232 filed on Mar. 26, 2024, incorporated herein by reference in its entirety.

### BACKGROUND

### 1. Technical Field

The present disclosure relates to a negative electrode and a lithium ion secondary battery.

### 2. Description of Related Art

Lithium ion secondary batteries represented by a non-aqueous electrolyte secondary battery and a solid-state battery are widely used as power sources of vehicles, cell phones, laptop computers, digital cameras, and the like in these years. An electrode used in a lithium ion secondary battery is produced, for example, by applying, on a conductive current collector, a slurry dispersing an active material (a positive electrode active material or a negative electrode active material), a binder, a conductive auxiliary agent and the like, and drying the resultant.

Japanese Unexamined Patent Application Publication No. 2015-041434 (JP 2015-041434 A) discloses that an electrode having an active material layer containing an active material and a binder formed on a current collector is adjusted to have a tortuosity of 1.1 or more and 1.5 or less for retaining capacity retention at 70% or more and 100% or less. JP 2015-041434 A also discloses that the densities of a positive electrode and a negative electrode are set to a prescribed range for obtaining the tortuosity falling in the above-described range. Japanese Unexamined Patent Application Publication No. 2009-199730 (JP 2009-199730 A) discloses a technique for preventing a voltage drop due to a micro short-circuit and improving the output of a secondary battery by employing a structure in which an insulating layer disposed between a positive electrode and a negative electrode includes two layers having different tortuosities.

On the other hand, Japanese Unexamined Patent Application Publication (Translation of PCT application) No. 2023-511881 (JP 2023-511881 A) discloses that at least a part of artificial graphite used as a negative electrode active material forms secondary particles, and that the proportion in number of the secondary particles to the total number of particles contained in the negative electrode active material is set to 50% or more. JP 2023-511881 A also discloses that an average particle size D50 of the artificial graphite used as the negative electrode active material is set to 15 μm or more. According to JP 2023-511881 A, excellent fast charging performance and long cycle life can be attained by using the negative electrode active material thus prescribed.

### SUMMARY

In the above-described technique, however, even when diffusion resistance is decreased by decreasing the tortuosity of an electrode for attaining fast charging of a lithium ion secondary battery, there arises a problem that a short circuit is caused in some cases because lithium is locally precipitated at the time of foreign matter contamination.

Therefore, an object of the present disclosure is to provide a negative electrode that has a low diffusion resistance enabling fast charging, and can prevent occurrence of a short circuit, and a lithium ion secondary battery including the negative electrode.

The present disclosure having achieved the above-described object encompasses the following:

<1> A negative electrode containing a negative electrode active material having an average particle size (D50) of 2 μm or more and 25 μm or less, and a proportion of secondary particles of 50% or more, wherein a tortuosity (T) is 1 or more and 20 or less, and a migration index (Ka) is 1.0 or more and 1.6 or less.

<2> The negative electrode according to <1>, wherein the negative electrode active material contains artificial graphite.

<3> A lithium ion secondary battery including: a positive electrode containing a positive electrode active material; the negative electrode according to <1> or <2>; and an electrolyte layer disposed between the positive electrode and the negative electrode.

According to the present disclosure, a negative electrode having a low diffusion resistance, and capable of preventing occurrence of a short circuit, and a lithium ion secondary battery including the negative electrode can be provided.

### DETAILED DESCRIPTION OF EMBODIMENTS

Now, embodiments of the present disclosure will be described. The following description is given merely for exemplifying the embodiments, and does not limit the scope of the present disclosure.

Herein, a numerical range described using “to” refers to a range including values before and after “to” as the minimum and maximum values.

In numerical ranges described herein in a stepwise manner, an upper limit value or a lower limit value of one numerical range may be placed with an upper limit value or a lower limit value of another numerical range described in a stepwise manner. Besides, in a numerical range described herein, an upper limit value or a lower limit value of the numerical range may be replaced with a value described in Examples.

Herein, the term “step” encompasses not only an independent step but also a step that cannot be definitely distinguished from another step as long as an intended purpose is achieved through the step.

Herein, each component may contain a plurality of corresponding substances. In the present embodiment, in description of the amount of each component in a composition, if a plurality of substances corresponding to each component is present in the composition, the amount means a total amount of the plurality of substances present in the composition unless otherwise stated.

A negative electrode of the present disclosure contains a negative electrode active material having an average particle size (D50) of 2 μm or more and 25 μm or less, and having a proportion of secondary particles of 50% or more, a tortuosity (T) thereof is 1 or more and 20 or less, and a migration index (Ka) thereof is 1.0 or more and 1.6 or less. The negative electrode of the present disclosure contains the negative electrode active material prescribed in the average particle size D50 and the proportion of secondary particles as described above, and has the tortuosity falling in the above-described range, and the migration index falling in the above-described range, and therefore, a low diffusion resistance desirable for fast charging performance is attained, and occurrence of a short circuit can be prevented.

### Negative Electrode Active Material

In the negative electrode of the present disclosure, an example of the negative electrode active material includes at least one selected from the group consisting of natural graphite, artificial graphite, soft carbon, hard carbon, Si, SiOx (0<x<2), a Si group alloy, Sn, SnOx (0<x<2), Li, a Li group alloy, and Li₄Ti₅O₁₂. In particular, in the negative electrode of the present disclosure, artificial graphite may be contained as the negative electrode active material.

### Average Particle Size (D50)

The average particle size (D50) is designated also as a median diameter, and refers to, in a volume-based particle size distribution of primary particles, a particle size at which a cumulative frequency value from a smaller particle size side reaches 50%. The particle size D50 of the negative electrode active material is a value measured by a laser diffraction method, and can be measured with a laser diffraction scattering particle size distribution measuring device. As the negative electrode active material having an average particle size (D50) of 2 μm or more and 25 μm or less, commercially available products prescribed in particle size can be appropriately used. In some embodiments, the average particle size (D50) is 2 μm or more and 18 μm or less.

### Secondary Particle

The negative electrode active material is in the form of either primary particles or secondary particles. The primary particle of the negative electrode active material refers to a single particle not in an aggregated state. The secondary particle refers to a particle in an aggregated state containing aggregation of two or more primary particles. The primary particle and the secondary particle can be easily distinguished from each other by obtaining a SEM image with a scanning electron microscope. A number percentage of the primary particles or the secondary particles in the negative electrode active material can be measured, for example, with a scanning electron microscope. Herein, the proportion of the secondary particles means a number percentage (%) of the secondary particles in all the particles of the negative electrode active material consisting of the primary particles and the secondary particles. The proportion of the secondary particles can be measured, for example, as follows.

First, a sheet on which particles of a negative electrode active material to be measured are adhered so as not to overlap with one another is prepared, and the numbers of primary particles and secondary particles included in a partial region of the sheet are counted with a scanning electron microscope. Then, a proportion of the number of the secondary particles to the total number of the primary particles and the secondary particles is calculated, and thus, the proportion of the secondary particles in the negative electrode active material can be obtained. The proportion of the secondary particles may be obtained in a plurality of, 10 for example, four regions in the sheet, and an average of the proportions in these four regions may be calculated as the proportion of the secondary particles.

A negative electrode active material having the proportion of the secondary particles of 50% or more can be prepared by producing secondary particles by, for example, a spray drying method using primary particles of a negative electrode active material, and mixing the resultant with the primary particles to obtain the proportion of the secondary particles of 50% or more.

When the proportion of the secondary particles in the negative electrode active material is 50% or more, a diffusion resistance can be low, and occurrence of a short circuit can be prevented. In the negative electrode of the present disclosure, the proportion of the secondary particles in the negative electrode active material is 50% or more, and the upper limit is not especially limited, and 100% of the particles may be secondary particles. In other words, in the negative electrode of the present disclosure, the proportion of the secondary particles in the negative electrode active material can be 50% to 100%, 50% to 90%, 50% to 80%, 50% to 70%, or 55% to 65%.

### Production of Negative Electrode

The negative electrode of the present disclosure includes a negative electrode current collector, and a layer that is disposed on the negative electrode current collector, and contains the above-described negative electrode active material (negative electrode active material layer). The negative electrode current collector is not especially limited, and may be in the shape of a foil, a plate, a mesh, a perforated metal, or a foam. Examples of a metal contained in the negative electrode current collector include Cu, Ni, Cr, Au, Pt, Ag, Al, Fe, Ti, Zn, Co, and stainless steel. In particular, from the viewpoint of ensuring reduction resistance, and from the viewpoint of difficulty in alloying with lithium, the negative electrode current collector may contain at least one metal selected from the group consisting of Cu, Ni, and stainless steel. For producing the negative electrode, for example, a slurry having the negative electrode active material, a binder, and another component dispersed in a dispersion medium is applied to the negative electrode current collector, and the resultant is dried.

### Tortuosity (T)

In the negative electrode produced as described above, the negative electrode active material layer has a tortuosity (T) of 1 or more and 20 or less. The tortuosity (T) can be calculated by a method described in, for example, Japanese Patent No. 5815617. Specifically, the tortuosity (T) can be obtained in accordance with the following expression (1):

$$T = f / s \qquad ( 1 )$$

wherein T is a tortuosity, f is a full length of a path that passes through a gap present between opposing two faces, and has openings on the opposing two faces, and s is a distance between the opposing two faces (thickness of the negative electrode).

f and s in the expression (1) can be obtained as follows. First, a three-dimensional image of a negative electrode to be measured is obtained, and the three-dimensional image is binarized into a region of the negative electrode active material, and a region of the gap. A path that has openings on one principal plane and another principal plane of the negative electrode, and has the gap continuously present therein in the thickness direction is thinned. Thus, the full length (f) of the path passing through the negative electrode to be measured, and the distance(s) between the one principal plane and the another principal plate of the negative electrode can be obtained.

It is noted that the tortuosity always has a value of 1 or more. A tortuosity of 1 means a straight path, and a tortuosity closer to 1 means that the path is closer to a straight line. When the tortuosity is more than 20, the diffusion resistance is so high that the negative electrode may not be suitable for fast charging. When the tortuosity is more than 20, a short circuit may occur. In some embodiments, the tortuosity is 1 or more and 9.0 or less. For adjusting the tortuosity of the negative electrode, a method can be employed in which a slurry containing a negative electrode active material, a binder, and another component dispersed in a dispersion medium is applied on a negative electrode current collector, the resultant is dried, and then the density of the negative electrode active material is adjusted by changing a pressure applied in roll pressing.

### Migration Index (Ka)

In the negative electrode produced as described above, the negative electrode active material layer has a migration index (Ka) of 1.0 or more and 1.6 or less. The migration index (Ka) refers to a numerical value quantitatively indicating a phenomenon, designated as binder migration, in which a binder component is unevenly distributed in the thickness direction. The migration index in the negative electrode refers to a numerical value indicating unevenness of a binder component contained in the negative electrode active material layer formed on the negative electrode current collector. The negative electrode active material layer is divided into two equal parts in the thickness direction, and assuming that a part closer to the negative electrode current collector is a lower part, and that a part disposed on the lower part is an upper part, a mass concentration (a) of the binder in the upper part and a mass concentration (B) of the binder in the lower part are obtained. The migration index in the negative electrode can be calculated as a/B.

More specifically, for example, the negative electrode is cut in the thickness direction with an ion milling device, and the thus obtained section is analyzed with an EPMA (Electron Probe Micro Analyzer). When the binder contains polyvinylidene fluoride (PVdF), the mass concentrations of the binder in the upper part and the lower part can be measured by using fluorine as an index. If the binder does not contain a characteristic element, the mass concentrations of the binder in the upper part and the lower part can be measured by selectively dyeing the binder.

A migration index (Ka) of a value more than 1 means that the binder is unevenly distributed in the upper part of the negative electrode active material layer, and a migration index (Ka) of less than 1 means that the binder is unevenly distributed in the lower part of the negative electrode active material layer. A migration index (Ka) of 1 means that the binder is evenly present in the upper part and the lower part of the negative electrode active material layer. The migration index can be adjusted in accordance with conditions employed in the drying performed after applying, on the negative electrode current collector, the slurry containing the negative electrode active material, the binder, and another component dispersed in the dispersion medium. For example, the migration index (Ka) can be controlled to be a higher value by setting a high drying temperature and/or performing quick drying after applying the slurry to the negative electrode current collector.

In some embodiments, the migration index is 1.0 or more and 1.6 or less, and from the viewpoint of preventing occurrence of a short circuit, is 1.0 or more and 1.2 or less.

### Lithium Ion Secondary Battery

The negative electrode of the present disclosure described above can be used as a negative electrode of a lithium ion secondary battery. A lithium ion secondary battery of the present disclosure includes a positive electrode containing a positive electrode active material, the above-described negative electrode, and an electrolyte layer disposed between the positive electrode and the negative electrode. In the lithium ion secondary battery of the present disclosure, the electrolyte layer may contain a liquid electrolyte without containing a solid electrolyte, the electrolyte layer may contain a solid electrolyte without containing a liquid electrolyte, or the electrolyte layer may contain a liquid electrolyte and a solid electrolyte. In some embodiments, when the electrolyte layer contains a liquid electrolyte, the electrolyte layer includes a separator for holding the liquid electrolyte, and preventing contact between the positive electrode and the negative electrode. When the electrolyte layer contains a solid electrolyte, the electrolyte layer may optionally contain a binder or the like in addition to the solid electrolyte.

As the solid electrolyte, any solid electrolytes usually used in solid-state batteries can be used without limitation. As such a solid electrolyte, crystalline nitrides, oxides, sulfides, and oxo acid salts, and materials having amorphous glass structures can be used. Specifically, an example of a sulfide solid electrolyte usable as the solid electrolyte includes at least one selected from the group consisting of LiI—LiBr—Li₃PS₄, Li₂S—SiS₂, LiI—Li₂S—SiS₂, LiI—Li₂S—P₂S₅, LiI—Li₂O—Li₂S—P₂S₅, LiI—Li₂S—P₂O₅, LiI—Li₃PO₄—P₂S₅, Li₂S—P₂S₅, Li₃PS₄, LiCl—LiBr—Li₃PS₄, LiCl—LiBr—Li₂S—P₂S₅, and LiCl—LiBr—Li₂S—SiS₂. Examples of an oxide-based solid electrolyte include Li_{0.34}La_{0.56}TiO₃, Li_{3/8}Sr_{7/16}Ta_{3/4}M_{1/4}O₃ (M is Zr or Hf), Li₇La₃Zr₂O₁₂, Li_{1.3}Al_{0.7}Ti_{1.3}(PO₄)₃, Li_{1.5}Al_{0.5}Ge_{1.5}(PO₄)₃, Li_{3.5}Ge_{0.5}V_{0.5}O, Li_{2.88}PO_{3.73}N_{0.14}, and Li_{2.9}Si_{0.45}PO_{1.6}N_{1.3}. In addition to these, a complex hydride lithium ionic conductor, a halide-based lithium ionic conductor or the like may be used as the solid electrolyte.

As the liquid electrolyte, any non-aqueous electrolyte solutions usually used in non-aqueous lithium ion secondary batteries can be used without limitation. The non-aqueous electrolyte solution may be a composition containing a supporting salt in a non-aqueous solvent. An example of the non-aqueous solvent includes a material selected from the group consisting of an organic electrolyte, a fluorine-based solvent, propylene carbonate (PC), ethylene carbonate (EC), diethyl carbonate (DEC), dimethyl carbonate (DMC), ethyl methyl carbonate (EMC), and a combination of two or more of these.

An example of the supporting salt includes a material selected from the group consisting of lithium compounds (lithium salts) such as Li(FSO₂)₂N, LiPF₆, LiBF₄, LiClO₄, LiAsF₆, LiCF₃SO₃, LiC₄F₉SO₃, LiN(CF₃SO₂)₂, LiC(CF₃SO₂)₃, and LiI, and a combination of two or more of these.

Examples of the binder used in the solid electrolyte include a butadiene rubber (BR)-based binder, a butylene rubber (IIR)-based binder, an acrylate butadiene rubber (ABR)-based binder, a styrene butadiene rubber (SBR)-based binder, a polyvinylidene fluoride (PVdF)-based binder, a polytetrafluoroethylene (PTFE)-based binder, and a polyimide (PI)-based binder. One of these binders may be singly used, or two or more of these may be used in combination.

As the separator used in the liquid electrolyte, any separators usually used in non-aqueous lithium ion secondary batteries may be used, and examples include those containing resins such as polyethylene (PE), polypropylene (PP), polyester, and polyamide. The separator may have a single layer structure, or a multilayer structure. Examples of a separator having a multilayer structure include a separator having a PE/PP two-layer structure, and a separator having a PP/PE/PP or PE/PP/PE three-layer structure. The separator may be a nonwoven fabric such as a cellulose nonwoven fabric, a resin nonwoven fabric, or a glass fiber nonwoven fabric.

The positive electrode includes a positive electrode current collector, and a positive electrode active material layer containing a positive electrode active material. The positive electrode current collector is not especially limited, and may be in the shape of a foil, a plate, a mesh, a perforated metal, or a foam. Examples of a metal contained in the positive electrode current collector include Cu, Ni, Cr, Au, Pt, Ag, Al, Fe, Ti, Zn, Co, and stainless steel. In particular, from the viewpoint of ensuring oxidation resistance, the positive electrode current collector may contain Al.

The positive electrode active material is not especially limited, and any of conventionally known materials can be appropriately used. Examples of the positive electrode active material include LiCoO₂, LiNiO₂, LiMnO₂, LiMn₂O₄, Li(NiCoMn)O₂, Li(NiCoAl)O₂, and LiFePO₄. The positive electrode active material particle may be a hi-nickel material (positive electrode active material containing a high percentage of Ni), a Li—Ni—Co—Mn-based composite oxide, or a ternary positive electrode active material.

It is noted that the lithium ion secondary battery may include another structure in addition to the positive electrode, the negative electrode, and the electrolyte layer described above. For example, the lithium ion secondary battery includes an insulating film enclosure for housing the positive electrode, the negative electrode, and the electrolyte layer, a positive electrode terminal member electrically connected to the positive electrode current collector, a negative electrode terminal member electrically connected to the negative electrode current collector, and a battery case for holding the insulating film enclosure housing the positive electrode, the negative electrode, and the electrolyte layer with ends to the positive electrode terminal member and the negative electrode terminal member exposed outside. When the lithium ion secondary battery is a non-aqueous lithium ion secondary battery using a liquid electrolyte, a battery case having an opening for injecting the liquid electrolyte can be used.

The lithium ion secondary battery of the present disclosure having the above-described structure uses the above-described negative electrode, and hence is improved in fast charging performance, and is desirable in safety because occurrence of a short circuit is inhibited. In the lithium ion secondary battery of the present disclosure, since the negative electrode having the tortuosity falling in the prescribed range is used as described above, ion diffusion can be accelerated, and diffusion resistance and overvoltage in charging can be inhibited, and therefore, the battery is suitable for fast charging. Here, fast charging is not especially limited, and means a charging method in which a charging speed is higher than in normal charging. The fast charging can be defined as charging in which electric power of, for example, 20 kW, 50 kW, 120 kW, or higher is supplied.

Besides, in the lithium ion secondary battery of the present disclosure, even though the negative electrode having the tortuosity falling in the above-described range is used, the migration index is specified in the above-described range, namely, the binder is unevenly distributed in a surface portion of the negative electrode active material layer (surface opposite to the negative electrode current collector side), and therefore, electron conductivity on the surface is reduced, and thus, occurrence of a short circuit can be prevented.

Now, the present disclosure will be described in more detail with reference to Examples, and it is noted that the technical scope of the present disclosure is not limited to the following Examples.

### Example 1

As a negative electrode active material, artificial graphite (average particle size (D50): 16.4 μm) was used. A degree of granulation employed in a secondary particle granulation step was controlled by using this material to set the proportion of the secondary particles to 60%. Then, a slurry containing the artificial graphite and having the following composition was prepared.
artificial graphite: 90% by mass
binder (PVdF): 5% by mass
conducting material (acetylene black): 5% by mass

The thus obtained slurry was applied to a copper foil, and the resultant was roll-pressed in a position of 0.1 mm under pressing pressure, and dried under conditions of 100° C. and 3 hours.

### Example 2

A negative electrode was produced in the same manner as in Example 1 except that the drying conditions were changed to 120° C. and 2 hours.

### Example 3

A negative electrode was produced in the same manner as in Example 1 except that the drying conditions were changed to 150° C. and 1 hour.

### Example 4

A negative electrode was produced in the same manner as in Example 2 except that artificial graphite (average particle size (D50): 2.4 μm) was used.

### Example 5

A negative electrode was produced in the same manner as in Example 2 except that artificial graphite (average particle size (D50): 4.9 μm) was used.

### Example 6

A negative electrode was produced in the same manner as in Example 2 except that artificial graphite (average particle size (D50): 10.7 μm) was used.

### Example 7

A negative electrode was produced in the same manner as in Example 2 except that artificial graphite (average particle size (D50): 24.3 μm) was used.

### Example 8

A negative electrode was produced in the same manner as in Example 2 except that the proportion of the secondary particles was changed to 50%.

### Example 9

A negative electrode was produced in the same manner as in Example 2 except that the roll pressing condition was changed to roll pressing performed in a position of 0.05 mm under pressing pressure.

### Example 10

A negative electrode was produced in the same manner as in Example 2 except that the roll pressing condition was changed to roll pressing performed in a position of 0.15 mm under pressing pressure.

### Comparative Example 1

A negative electrode was produced in the same manner as in Example 1 except that the drying conditions were changed to 60° C. and 4 hours.

### Comparative Example 2

A negative electrode was produced in the same manner as in Example 1 except that the drying conditions were changed to 200° C. and 30 minutes.

### Comparative Example 3

A negative electrode was produced in the same manner as in Example 2 except that artificial graphite (average particle size (D50): 1.9 μm) was used.

### Comparative Example 4

A negative electrode was produced in the same manner as in Example 2 except that artificial graphite (average particle size (D50): 26.7 μm) was used.

### Comparative Example 5

A negative electrode was produced in the same manner as in Example 2 except that the proportion of the secondary particles was changed to 30%.

### Comparative Example 6

A negative electrode was produced in the same manner as in Example 2 except that the proportion of the secondary particles was changed to 40%.

### Comparative Example 7

A negative electrode was produced in the same manner as in Example 2 except that the roll pressing condition was changed to roll pressing performed in a position of 0.2 mm under pressing pressure.

### Measurement of Tortuosity

In the negative electrodes of Examples 1 to 10 and Comparative Examples 1 to 7, the tortuosity (T) was calculated by the method described in Japanese Patent No. 5815617. Specifically, a three-dimensional image of each negative electrode to be measured was obtained, and the three-dimensional image was binarized into a region of the negative electrode active material, and a region of a gap. A path that had openings on one principal plane and another principal plane of the negative electrode, and had the gap continuously present therein in the thickness direction was thinned. Thus, the full length (f) of the path passing through the negative electrode to be measured, and the distance(s) between the one principal plane and the another principal plate of the negative electrode were obtained to calculate T=f/s.

### Measurement of Migration Index

In the negative electrodes of Examples 1 to 10 and Comparative Examples 1 to 7, the migration index was measured under the following conditions. Specifically, PVdF was dyed, each negative electrode was cut in the thickness direction with an ion milling device, and the thus obtained section was analyzed with an EPMA (Electron Probe Micro Analyzer) to measure the migration index.

### Measurement of Resistance Value

In the negative electrodes of Examples 1 to 10 and Comparative Examples 1 to 7, the resistance value was measured under the following conditions. A test battery was produced using each of the negative electrodes of Examples 1 to 10 and Comparative Examples 1 to 7, and the resistance value was calculated based on a voltage drop ΔV caused by discharging at a 1C equivalent rate for 10 second in initial discharge, and a current value. The resistance value was obtained by standardizing the resistance value of the test battery using the negative electrode of each of Examples 1 to 10 and Comparative Examples 2 to 7 by assuming that the resistance value of the test battery using the negative electrode of Comparative Example 1 was 1.00.

### Short Circuit Test

Each of the negative electrodes of Examples 1 to 10 and Comparative Examples 1 to 7 was used to produce a test battery, and a short circuit test was performed using the following experimental equipment. The experimental equipment used for performing the short circuit test included a drilling machine having a piercing nail fixed thereon, an XYZ stage, a resistance measuring device, a dial gauge, a thermocouple, and a computer. This equipment had a structure in which the piercing nail is fixed at the tip of the drilling machine, a test battery is fixed on the XYZ stage below the drilling machine, and the test battery is elevated at a prescribed rate with the height of the test battery measured with the dial gauge to measure the temperature, a DC resistance, and the displacement for inputting the resultant to the computer. The thermocouple was put and fixed on the surface of the test battery, the test battery was sandwiched between heat insulating plates, and the nail was pierced by 4 mm to measure the displacement and temperature change. When the temperature increase was 150° C. or less, the result of the short circuit test was determined as good, and when the temperature increase was larger than 150° C., the result of the short circuit test was determined as poor.

### Results

The resistance values and the results of the short circuit test obtained by changing the migration index are shown in Table 1 (Comparative Examples 1 and 2, and Examples 1 to 3).

TABLE 1

| | | Proportion | | | | |
|---|---|---|---|---|---|---|
| | | of | | | | |
| | | Secondary | | | | Short |
| | D50 | Particles | | Standardized | Migration | Circuit |
| | (μm) | (%) | Tortuosity | Resistance | Index | Test |
| Com. | 16.4 | 60 | 12.0 | 1.00 | 0.93 | poor |
| Ex. 1 | | | | | | |
| Ex. 1 | 16.4 | 60 | 12.0 | 0.93 | 1.02 | good |
| Ex. 2 | 16.4 | 60 | 12.0 | 0.93 | 1.20 | good |
| Ex. 3 | 16.4 | 60 | 12.0 | 0.95 | 1.56 | good |
| Com. | 16.4 | 60 | 12.0 | 1.24 | 1.68 | poor |
| Ex. 2 | | | | | | |

Next, the resistance values and the results of the short circuit test obtained by using artificial graphite having different D50s are shown in Table 2 (Comparative Examples 3 and 4, and Example 2, and 4 to 7).

TABLE 2

| | | Proportion | | | | |
|---|---|---|---|---|---|---|
| | | of | | | | |
| | | Secondary | | | | Short |
| | D50 | Particles | | Standardized | Migration | Circuit |
| | (μm) | (%) | Tortuosity | Resistance | Index | Test |
| Com. | 1.9 | 60 | 12.0 | 1.31 | 1.20 | poor |
| Ex. 3 | | | | | | |
| Ex. 4 | 2.4 | 60 | 12.0 | 0.92 | 1.20 | good |
| Ex. 5 | 4.9 | 60 | 12.0 | 0.89 | 1.20 | good |
| Ex. 6 | 10.7 | 60 | 12.0 | 0.91 | 1.20 | good |
| Ex. 2 | 16.4 | 60 | 12.0 | 0.93 | 1.20 | good |
| Ex. 7 | 24.3 | 60 | 12.0 | 0.94 | 1.20 | good |
| Com. | 26.7 | 60 | 12.0 | 1.26 | 1.20 | poor |
| Ex. 4 | | | | | | |

Next, the resistance values and the results of the short circuit test obtained by changing the proportion of the secondary particles are shown in Table 3 (Comparative Examples 5 and 6, and Examples 2 and 8).

TABLE 3

| | | Proportion | | | | |
|---|---|---|---|---|---|---|
| | | of | | | | |
| | | Secondary | | | | Short |
| | D50 | Particles | | Standardized | Migration | Circuit |
| | (μm) | (%) | Tortuosity | Resistance | Index | Test |
| Com. | 16.4 | 30 | 12.0 | 1.25 | 1.20 | poor |
| Ex. 5 | | | | | | |
| Com. | 16.4 | 40 | 12.0 | 1.19 | 1.20 | poor |
| Ex. 6 | | | | | | |
| Ex. 8 | 16.4 | 50 | 12.0 | 0.94 | 1.20 | good |
| Ex. 2 | 16.4 | 60 | 12.0 | 0.93 | 1.20 | good |

Next, the resistance values and the results of the short circuit test obtained by changing the tortuosity are shown in Table 4 (Comparative Example 7, and Examples 2, 9 and 10).

TABLE 4

| | | Proportion | | | | |
|---|---|---|---|---|---|---|
| | | of | | | | |
| | | Secondary | | | | Short |
| | D50 | Particles | | Standardized | Migration | Circuit |
| | (μm) | (%) | Tortuosity | Resistance | Index | Test |
| Ex. 9 | 16.4 | 60 | 5.3 | 0.69 | 1.20 | good |
| Ex. 2 | 16.4 | 60 | 12.0 | 0.93 | 1.20 | good |
| Ex. | 16.4 | 60 | 19.6 | 0.95 | 1.20 | good |
| 10 | | | | | | |
| Com. | 16.4 | 60 | 21.6 | 1.33 | 1.20 | poor |
| Ex. 7 | | | | | | |

As described so far, based on the results of Examples 1 to 10 and Comparative Examples 1 to 7, it was found that a negative electrode having a low resistance, and capable of preventing occurrence of a short circuit can be obtained by using a negative electrode that contains a negative electrode active material having an average particle size (D50) of 2 μm or more and 25 μm or less, and having a proportion of secondary particles of 50% or more, has a tortuosity (T) of 1 or more and 20 or less, and has a migration index (Ka) of 1.0 or more and 1.6 or less.

What is claimed is:

1. A negative electrode comprising a negative electrode active material having an average particle size of 2 μm or more and 25 μm or less, and a proportion of secondary particles of 50%, wherein:
a tortuosity is 1 or more and 20 or less; and
a migration index is 1.0 or more and 1.6 or less.

2. The negative electrode according to claim 1, wherein the negative electrode active material comprises artificial graphite.

3. A lithium ion secondary battery comprising:
a positive electrode comprising a positive electrode active material;
the negative electrode according to claim 1; and
an electrolyte layer disposed between the positive electrode and the negative electrode.
